(19) United States
(12) Patent Application Publication
(10) Pub. No.: US 2026/0193434 A1
(43) Pub. Date: Jul. 9, 2026

(54) COMPOSITE BIOPLASTIC MATERIAL

(71) Applicant: QinetiQ Limited, Hampshire (GB)

(72) Inventors: Roya ASHAYER-SOLTANI, Hampshire (GB); Paul Thomas DUFF, Hampshire (GB)

(21) Appl. No.: 19/133,805

(22) PCT Filed: Nov. 22, 2023
(86) PCT No.: PCT/EP2023/082758

§ 371 Date: May 29, 2025

(30) Foreign Application Priority Data
Nov. 30, 2022 (GB) 2217973.3

(51) Int. Cl. C08J 7/04; C08K 3/36; C08K 5/09; C08K 5/11; C08L 67/04; C08L 89/06; C09D 7/63; C09D 191/00

(52) U.S. Cl. CPC C08J 7/0427; C08K 3/36; C08K 5/11; C08L 67/04; C08L 89/06; C09D 7/63; C09D 191/00; C08J 2367/04; C08J 2389/06; C08J 2467/04; C08J 2489/06; C08J 2491/00; C08K 5/09; C08L 2203/16; C08L 2205/06

(57) ABSTRACT

A composite material and method can include a bioplastic film, the bioplastic film including a first surface and a second surface, wherein the first surface denotes an inner facing surface and the second surface denotes an exterior facing surface. The bioplastic film can include a polypeptide-based or polysaccharide-based biopolymer, or a mixture of polypeptide-based and polysaccharide based biopolymer, and a bioplasticiser substance. An inner product-facing surface of the bioplastic film can include a coating that includes alpha-eleostearic acid as a major component. Further provided are products containing the material and their uses in the fields of packaging, coatings and ink-printable substrates.

This application is a national phase filing under 35 C.F.R. § 371 of and claims priority to PCT Application No. PCT/EP2023/082758, filed on Nov. 22, 2023, which claims the priority benefit under 35 U.S.C. § 119 of British Patent Application No. 2217973.3, filed on Nov. 30, 2022, the contents of each of which are hereby incorporated by reference in their entireties.

### FIELD

The disclosed subject matter is in the field of producing biodegradable and/or compostable bioplastic films, particularly polypeptide-based films. In particular, the disclosed subject matter is in the field of smart biodegradable, compostable bioplastic films for use in the fields of packaging, including smart packaging, coatings, including smart coatings, ink-printable substrates, including for use in packaging or single-use electronics including single-use sensors, and bubble wrap.

### BACKGROUND

The disposal of plastic waste has become an urgent global problem, with plastic packaging being particularly problematic due to its ubiquity and extended decomposition times. Recycling of plastic, including plastic packaging, for example in sandwich packaging, is often problematic due to the use of non-recyclable films. Such plastics are often disposed of by incineration leading to significant greenhouse gas emissions, including carbon dioxide (CO₂) and the production of carbon black, whose potential to contribute to global warming is up to 5000 times greater than CO₂. In 2022 alone, researchers estimate that the production and incineration of non-recyclable plastic will generate upwards of 850 million tonnes of greenhouse gasses, that number potentially increasing to 2.8 billion tonnes by the year 2050 (https://www.wwf.org.au/news/blogs/plastic-waste-and-climate-change-whats-the-connection#:~:text=Globally%2C%20in%20this%20year%20alone,rise%20to%202.8%20billion%20tonnes). Additionally, marine plastics break down into micro plastics which enter the food chain by accumulating in living organisms, including plankton and humans. Plankton sequesters between 30%-50% of all anthropogenic CO₂. However, upon accumulating microplastics, plankton's ability to remove CO₂ from the atmosphere significantly decreases, contributing to accelerated global warming.

Currently, flexible plastic packaging makes up one quarter of the United Kingdom's consumer packaging, of which only 6% is recycled; for example, over 4 billion sandwich packets are disposed of in the United Kingdom every year and not recycled. Such and other single use plastics, such as those used for fruit, vegetable and meat packaging, are mostly incinerated, sent to landfill or otherwise discarded. Reports, such as NielsenIQ (https://nielseniq.com/global/en/insights/analysis/2019/a-natural-rise-in-sustainability-around-the-world/) suggest that a significant majority of consumers are willing to change their consumption habits to reduce environmental impacts, with approximately half willing to switch to environmentally friendly products.

As such, there exists a growing demand for cheap, sustainable environmentally friendly solutions for a growing eco-conscious consumer market to the problems posed by single-use plastics. Biocompatible plastics, or bioplastics, offer such a solution. They may be sustainably produced from renewable feedstocks and may be biodegradable and/or compostable. Demand for bioplastics increases year on year and have the potential to reduce CO₂ emissions by between 30%-70%, as compared to conventional synthetic plastic, typically derived from petrochemical sources.

There also exists further demand for bioplastics with additional functionality, so-called “smart bioplastics”, for example, capable of extending the shelf-life of perishable items, including foods and medicines, via the inhibition of microbial growth. Other functionalities of smart bioplastics include the ability to respond to external stimuli, such as environmental pH, to act as a sensor, or act as printable substrates for inks, including functional inks, such as electronically conductive inks, for example, for use in single-use electronic sensors or printed circuit board (PCBs). Such plastics should also be durable, capable of sustaining a useful lifetime for the desired usage, but also biodegrade with minimal environmental impact within a desirably short timescale of days, weeks, and months, as opposed to years.

The presently disclosed subject matter addresses the problems that exist in the prior art, in providing a multifunctional smart bioplastic for use in a variety of industrial applications, including, but not limited to packaging and single-use electronics.

### SUMMARY

The present inventors have developed compositions and methods that provide for the utilisation of biopolymers sourced from renewable feedstocks to generate biodegradable and/or compostable, flexible bioplastics and smart bioplastics. These novel materials which show utility in the following exemplary, non-limiting applications: packaging; smart packaging; single-use electronic sensors and devices; and protective wrapping.

In a first aspect the disclosed subject matter provides a composite material comprising a bioplastic film, the bioplastic film including a first surface and a second surface, wherein the first surface denotes an inner facing surface and the second surface denotes an exterior facing surface,
wherein the bioplastic film is comprised of a polypeptide-based or polysaccharide-based biopolymer, or a mixture of polypeptide-based and polysaccharide based biopolymer, and a bioplasticiser substance; and
wherein the inner product-facing surface of the bioplastic film comprises a coating that includes alpha-eleostearic acid as a major component.

In a second aspect, the disclosed subject matter provides a method for the production of a bioplastic film, the method comprising:
(i) providing a polypeptide-based biopolymer, wherein the polypeptide-based biopolymer is dissolved in water in a ratio by weight of: at most 1:10; at most 1:20; at most 1:30; at most 1:40; at most 1:50; at most 1:60; at most 1:70; at most 1:80; at most 1:90; at most 1:100;
(ii) combining the dissolved polypeptide-based biopolymer with a small molecule hydrophilic bioplasticiser;
(iii) wherein the small molecule hydrophilic bioplasticiser is added to the polypeptide-based biopolymer solution in a mixing ratio by weight with respect to itself and the biopolymer of: at most 50 w/w %; at most 25 w/w %; at most 20 w/w %; at most 10 w/w %, at most 5 w/w %, at most 1 w/w %, at most 0.5 w/w %, or at most 0.1 w/w %; and at least 0.01 w/w %;
(iv) using the combined polypeptide-based biopolymer/bioplasticiser mixture to generate a bioplastic film; and
(v) applying a coating comprising alpha-eleostearic acid as a major component to at least one surface of the bioplastic film;
optionally, wherein the polypeptide-based biopolymer comprises gelatine and/or the hydrophilic bioplasticiser comprises triethylcitrate (TEC).

In a third aspect disclosed subject matter provides a method for the production of a bioplastic film, the method comprising:
(i) providing a polypeptide-based biopolymer, wherein the polypeptide-based biopolymer is dissolved in water in a ratio by weight of: at most 1:10; at most 1:20; at most 1:30; at most 1:40; at most 1:50; at most 1:60; at most 1:70; at most 1:80; at most 1:90; at most 1:100;
(ii) combining the dissolved polypeptide-based biopolymer with a polymeric hydrophilic bioplasticiser;
(iii) wherein the polymeric hydrophilic bioplasticiser is combined with the polypeptide-based biopolymer with a mixing ratio by weight with respect to itself and the polypeptide-based biopolymer of: at most 75 w/w %; at most 67 w/w %; at most 50 w/w %; at most 33 w/w %; at most 25 w/w %; or at most 20 w/w %; and at least 0.01 w/w %;
(iv) using the combined polypeptide-based biopolymer/hydrophilic bioplasticiser mixture to generate a film; and
(v) applying a coating comprising alpha-eleostearic acid as a major component to at least one surface of the bioplastic film;
optionally, wherein the polypeptide-based biopolymer comprises gelatine and/or the polymeric hydrophilic bioplasticiser comprises poly(glycerol-citrate) (PGC).

In a fourth aspect the disclosed subject matter provides a method for the production of a bioplastic film, the method comprising:
(i) providing a polypeptide-based biopolymer, wherein the polypeptide-based biopolymer is dissolved in water in a ratio by weight of: at most 1:10; at most 1:20; at most 1:30; at most 1:40; at most 1:50; at most 1:60; at most 1:70; at most 1:80; at most 1:90; at most 1:100;
(ii) combining the dissolved polypeptide-based biopolymer with a mixture of a polymeric hydrophilic bioplasticiser and a small molecule hydrophilic bioplasticiser;
(iii) wherein the polymeric hydrophilic bioplasticiser and the small molecule hydrophilic bioplasticiser are mixed in any ratio; optionally wherein the polymeric hydrophilic bioplasticiser and the small molecule hydrophilic bioplasticiser are mixed in a ratio by weight of: at most 5:1; at most 4:1; at most 3:1; at most 2:1; at most 1:1; at most 1:2; at most 1:3; at most 1:4; or at most 1:5;
(iv) the hydrophilic bioplasticiser mixture is combined with the polypeptide-based biopolymer with a mixing ratio by weight of: at most 90 w/w %; at most 85 w/w %; at most 80 w/w %; at most 75 w/w %; at most 67 w/w %; at most 50 w/w %; at most 33 w/w %; at most 25 w/w %; at most 20 w/w %; at most 15 w/w %; or at most 10 w/w %; and at least 0.01 w/w %.
(v) using the combined polypeptide-based biopolymer/hydrophilic bioplasticiser mixture to generate a film; and
(vi) applying a coating comprising alpha-eleostearic acid as a major component to at least one surface of the bioplastic film;
optionally, wherein the polypeptide-based biopolymer comprises gelatine and/or the polymeric hydrophilic bioplasticiser comprises poly(glycerol-citrate) (PGC) and the small molecule hydrophilic bioplasticiser comprises triethylcitrate (TEC).

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

The disclosed subject matter is illustrated by the following non-limiting drawings in which:

FIG. 1 shows samples of the bioplastic films of the disclosed subject matter (gelatine and TEC) according to certain embodiments a)-d) as described in Table 1.

FIG. 2 shows a sample the bioplastic film of the disclosed subject matter (gelatine and TEC/PGC) according to an embodiment as described in Table 3.

FIG. 3 shows a sample the bioplastic film of the disclosed subject matter according to an embodiment (Formulation 5.1) as described in Table 5 showing the effect of exposure to acidic (right) and basic (left) conditions.

FIG. 4 shows samples of the bioplastic films of the disclosed subject matter (Formulations 4.1-4.4) according to certain embodiments a)-d) as described in Table 1.

FIG. 5 shows a) the printing stencil; b) the silver-based conductive ink printed onto the polypeptide-based bioplastic film of the disclosed subject matter; the effect of bending the films made with c) PGC and d) TEC after curing at 80° C.

FIG. 6 shows printed carbon ink on a polypeptide-based bioplastic film of the disclosed subject matter; and dissolving the bioplastic film and ink in water.

FIG. 7 shows a) printed silver ink on a polypeptide-based bioplastic film of the disclosed subject matter; b)-c) immersion of the silver ink-printed bioplastic film in water and precipitation of the silver-polymer binder; and d) recovery of the silver particles after decantering of the water and washing with acetone.

FIG. 8 shows the cutter shape; and the shaped polypeptide-based bioplastic films used for tensile strength measurements.

FIG. 9 shows the universal testing machine holding grips and the torn bioplastic films of the disclosed subject matter used for tensile strength measurements.

FIG. 10 shows various custom-made silicon and commercial bubble wrap moulds a)-e) used to create a bubble wrap product according to certain embodiments of the current disclosed subject matter.

FIG. 11 shows a bioplastic bubble wrap of the disclosed subject matter generated using a) 120 mL solution feedstock; b) 80 mL solution feedstock; and c) the effect of folding on the bioplastic bubble wrap.

FIG. 12 shows a polypeptide-based bioplastic film of the disclosed subject matter laminated onto a piece of paper demonstrating compound packaging.

FIG. 13 shows a graph of the absorption of anthocyanin at pH 4.5.

### DETAILED DESCRIPTION

All references cited herein are incorporated by reference in their entirety. Unless otherwise defined, all technical and scientific terms used herein have the same meaning as commonly understood by one of ordinary skill in the art to which this disclosed subject matter belongs.

One problem with previously known bio-based biodegradable or compostable plastic films is that such films have poor moisture barrier and oxygen barrier properties. As a result, such films have previously shown poor performance when used exclusively in packaging. Further, many biodegradable films are brittle and stiffer than petrochemical derived oriented polypropylene (OPP) films typically used for flexible film packages—e.g. for edible snack and candy wrappers. The presently disclosed subject matter provides novel composite materials that demonstrate improved barrier properties and also the benefit of biodegradation or compostability.

Prior to setting forth the disclosed subject matter in greater detail, a number of definitions are provided that will assist in the understanding of the disclosed subject matter.

As used herein, the term “comprising” means any of the recited elements are necessarily included and other elements may optionally be included as well. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this disclosed subject matter.

The term “composite material” is used to refer to a material that comprises two or more constituents bonded together, typically in the form of a laminar or coated substrate configuration. In specific embodiments of the disclosed subject matter, the composite material comprises a substrate and at least one coating that is applied to at least a first surface of the substrate. The composite material may comprise one or more core polymer substrate layers and one or more barrier layers. Optionally, the one or more barrier layers may be in the form of a coating layer applied to a surface of the composite material.

The term “film” is used herein to denote a substantially planar substrate of solid, non-fluid polymer-containing material ranging in thickness from the length scale of nanometres to millimetres. A film, being a planar material, suitably a free-standing substrate and thus, defines at least a first and a second surface. A “bioplastic film” is used herein to denote a plastic film comprising material produced by or derived from any living organism or biological process, including but not limited to plants, fungi, bacteria, archaea and animals. When used in the context of packaging, the first surface may constitute an inner or product-facing surface and the second surface may denote an exterior facing surface, e.g. one that is open to the surrounding environment.

The term “biopolymer” assumes is commonly accepted meaning referring to a polymeric material produced by or derived from any living organism, including but not limited to plants, fungi, bacteria, archaea and animals.

A “polypeptide-based biopolymer” is a polymer of amino acid residues joined by peptide bonds, whether produced naturally or in vitro by synthetic means. A polypeptide of less than around 12 amino acid residues in length is typically referred to as a “peptide”. The term “polypeptide” as used herein denotes the product of a naturally occurring polypeptide, precursor form or proprotein. Polypeptides also undergo maturation or post-translational modification processes that may include, but are not limited to: glycosylation, proteolytic cleavage, crosslinking, lipidisation, signal peptide cleavage, propeptide cleavage, phosphorylation, and such like. A “protein” is a macromolecule comprising one or more polypeptide chains.

The term “hydrolysed protein” assumes its common meaning, referring to any material comprising a mixture of amino acids, peptides, polypeptides and denatured proteins derived from the chemical, enzymatic or thermal hydrolysis of biologically-derived proteins.

The term “gelatine” assumes its common meaning, referring to the product derived from the hydrolysis of collagen sourced from various animal body parts and/or plants. Suitably, gelatine may be derived as a by-product of meat processing, and may be of porcine, bovine, marine, insect, or avian origin. The traditional process for producing gelatine involves boiling collagenous animal tissues and bones until they congeal into a gel-like substance referred to as gelatine.

A “polysaccharide-based biopolymer” as defined herein refers to a long chain carbohydrate that contains a plurality of monosaccharide units in linear or branched form. The polysaccharide used in accordance with embodiments of the presently disclosed subject matter may be any polysaccharide that can be subjected to melt mixing. The polysaccharide will generally have a low water content, typically below about 1 wt. %, for example below about 0.5 wt. %. Suitable polysaccharides include, but are not limited to, starch, cellulose, glycogen, and chitosan, as well as derivatives or combinations thereof. The term “plasticiser” assumes its common meaning referring to a substance which is added to a material to make said material more soft, more flexible, decreasing its viscosity and increasing its plasticity. The term “bioplasticiser” is used herein to denote a plasticiser produced by or derived from any living organism or biological process, including but not limited to plants, fungi, bacteria, archaea and animals. The term “small molecule bioplasticiser” refers a plasticiser comprising a discrete molecule, typically with a molecular weight of less than 1000 Da, and not comprising many repeat units, where “not comprising many repeat units” refers typically to less than ten repeat units. The term “polymeric bioplasticiser” refers a plasticiser comprising a polymer, typically with a molecular weight greater than 1000 Da, and comprising many repeat units, where “many repeat units” refers typically to greater than ten repeat units.

The term “free acid” used herein refers to an acidic functional group in its protonated form. For example, the free acid form of an alkyl ester, whose functional group is denoted by the general formula —COOR, where R is any hydrocarbon radical, is-COOH. The term “alkali salt form” used herein refers to a basic functional group coordinated with an alkali cation. For example, the alkali salt form of an alkyl ester, whose functional group is denoted by the general formula —COOR, where R is any hydrocarbon radical, is —COOA, where A is an alkali earth metal cation (e.g. Na⁺).

The term “C1-C6” used herein refers to any saturated or unsaturated branched or non-branched hydrocarbon containing between one and six carbon atoms. Typically, “C1-C6” refers to the group of saturated n-hydrocarbons comprising methyl, ethyl, n-propyl, n-butyl, n-pentyl and n-hexyl groups. The term “C2-C4” used herein refers to any saturated or unsaturated branched or non-branched hydrocarbon containing between two and four carbon atoms. Typically, “C2-C4” refers to the group of saturated n-hydrocarbons comprising ethyl, n-propyl and n-butyl groups.

The term “sensor substance” used herein refers to any substance possessing a property which may undergo a measurable and/or observable change upon interaction with an external stimulus, including but not limited to, colour, conductivity and transparency. The sensor substance may be used to convey information about the state of a target entity, for example the target entity being a food item or pharmaceutical product contained within a packaging comprising the sensor substance. The “state” of the target entity may include, but is not limited to, age, freshness and tampering, where “tampering” refers to the unauthorised access to, adulteration of and/or or manipulation of the target entity.

The term “pH indicator” used herein refers to any substance possessing a property which may undergo any measurable and/or observable change over a defined range of pH values. Typically, the measurable and/or observable change is light absorption.

The term “biodegradable” assumes is common meaning referring to the decomposition of matter by exposure to environmental conditions including sunlight, heat, water, oxygen, pollutants, microorganisms, enzymes, insects, animals and/or other living organisms, such as fungi. The term “compostable” assumes its common meaning, referring to the aerobic decomposition of organic matter into humus. The term “compostable” is not interchangeable with the term “biodegradable” as for something to be compostable it must degrade within the time specified by standards such as: ASTM D6400 or ASTM D6868; or optionally, additionally one or more of the standards: ASTM D5338, EN 12432, AS 4736, ISO 17088 or ISO 14855.

The term “bubble wrap” relates to a class of protective wrapping and assumes its commonly accepted meaning referring to a plastic sheet material containing numerous small air cushions designed to protect fragile goods. In general, protective wrapping is used to insulate or provide mechanical protection to products during shipping or storage.

The term “diatomaceous earth” assumes its common meaning referring to the naturally occurring soft, siliceous sedimentary rock derived from the fossilised remains of diatoms, photosynthesising algae.

The term “packaging” used herein refers to any items used to transport, store or protect goods. Examples of packaging according to the present disclosure include, but are not limited to, wrappers, pouches, bags, sacks and envelopes. In some embodiments, packaging is used to protect food items, including, for example, sandwiches or fast-food items.

The presently disclosed subject matter recognises the problem of providing a disposable, biodegradable, compostable, flexible bioplastic film for use in an assortment of applications, including but not limited to packaging, including smart packaging, and coatings, including smart coatings, and single-use electronics, including single-use sensors, and bubble wrap.

In one aspect, a solution to some or all of these problems, as well as to other problems that may or may not be specified in the current disclosure, is provided in the form of a bioplastic film comprising a polypeptide-based biopolymer blended with at least one small molecule hydrophilic bioplasticiser and/or at least one polymeric hydrophilic bioplasticiser; wherein the components are combined by mixing by any means, including, for example, mechanical, ultrasonic or microwave mixing. Suitably, the bioplastic film is at least biodegradable, and in specific embodiments of the disclosed subject matter the bioplastic film is compostable.

In specific embodiments of the disclosed subject matter the polypeptide-based biopolymer may be a protein-derived biopolymer; optionally wherein the protein-derived biopolymer comprises a hydrolysed protein.

In other specific embodiments of the disclosed subject matter the hydrolysed protein is derived from collagen, and may suitably comprise gelatine from any natural or synthetic source.

In alternative embodiments, the polysaccharide-based biopolymer is starch. Starch is a particularly convenient polysaccharide in that it is relatively inexpensive, it is generally obtainable from renewable sources and is, thus, readily available. Starch is found chiefly in seeds, fruits, tubers, roots and stem pith of plants. Starch is a polymer made up of repeating glucose groups linked by glucosidic linkages in the 1-4 carbon positions. It comprises or consists of two types of alpha-D-glucose polymers: amylose, a substantially linear polymer with molecular weight of about 1×10⁵, and amylopectin, a highly branched polymer with very high molecular weight of the order 1×10⁷. Each repeating glucose unit typically has three free hydroxyl groups, thereby providing the polymer with hydrophilic properties and reactive functional groups. Typically starches contain 20 to 30 wt % amylose and 70 to 80 wt % amylopectin. It is possible to vary the ratio of amylose to amylopectin by selecting a different origin for the starch. By way of example, waxy corn starch may contain up to 100 wt % of amylopectin. Starch usually has a water content of about 15 wt %. However, the starch can be dried to reduce its water content to below 1 wt % thereby improving its properties as a substrate for manufacture of films. Alternatively, in embodiments of the disclosed subject matter the polysaccharide-based polymer is cellulose. Cellulose is the most abundant natural polymer in the world. Cotton fibre is one of the purest sources of cellulose, it may also be derived from other sources including hemp and bacteria. Raw cotton is composed of more than 95% cellulose. Cellulose is made up of beta-D-glucopyranose units. These units are linked together by 1-4 glycosidic bonds making long chains of cellulose. Each unit is rotated 180° around the molecular axis. Each anhydroglucose unit contains one primary hydroxyl group and two secondary hydroxyl groups. The reactivity of the hydroxyl group affects the chemical reactivity and the response to thermal treatment of the cellulose. Cellulose molecules are organized into crystallites in parallel arrangements followed by elementary fibrils. An elementary fibril with a diameter of about 3.5 nm is made of about 36 cellulose chains. These fibrils aggregate to form microfibrils with a diameter of 10 to 30 nm. Microfibrils subsequently are associated into large aggregates called macrofibrils with a diameter varying from 60 nm to 360 nm. Numerous intra- and intermolecular hydrogen bonds are formed between the hydrogen and oxygen molecules in cellulose. This force leads to very strong microfibrils that can be used to manufacture strong bioplastic films.

In specific embodiments of the disclosed subject matter the small molecule hydrophilic bioplasticiser is selected from the group consisting of: an epoxidized soybean oil; a castor oil; a palm oil; an alkyl citrate; an alkyl glycolate; an alkyl succinate; an alkyl glutarate; an alkyl stearate; an alkyl oleate; or any derivative thereof, including but not limited to their free acid and alkali salt forms, wherein the alkyl group is at least one C1-C6 alkyl group; an isosorbide; a cardanol; a polyhydric alcohol; or any derivative thereof. In embodiments the small molecule bioplasticiser is blended with the polypeptide-based biopolymer in any suitable ratio to generate a bioplastic film. In specific embodiments the small molecule bioplasticiser is blended with the polypeptide-based biopolymer dissolved in water in a ratio by weight with respect to the polypeptide-based biopolymer of: at most 50 w/w %; at most 25 w/w %; at most 20 w/w %; at most 10 w/w %, at most 5 w/w %, at most 1 w/w %, at most 0.5 w/w %, or at most 0.1 w/w %; and at least 0.01 w/w %; wherein the polypeptide-based biopolymer is dissolved in water in a ratio of: at most 1:10; at most 1:20; at most 1:30; at most 1:40; at most 1:50; at most 1:60; at most 1:70; at most 1:80; at most 1:90; at most 1:100. In specific embodiments of the disclosed subject matter, the small molecule hydrophilic bioplasticiser comprises triethylcitrate (TEC). In a further specific embodiment of the disclosed subject matter, TEC is blended with the polypeptide-based biopolymer dissolved in water, wherein the polypeptide-based biopolymer comprises gelatine, in a ratio by weight of 13.2 w/w %; wherein the gelatine is dissolved in water in a ratio by weight of 1.5:40.

In other embodiments of the disclosed subject matter the hydrophilic bioplasticiser comprises a polymeric bioplasticiser. The polymeric hydrophilic bioplasticiser may be selected from the group consisting of the polycondensation product of a small molecule polycarboxylic acid selected from the group consisting of: a citrate; a succinate; a glutarate; and a polyol selected from the group consisting of: glycerol; ethylene glycol; propylene glycol. In specific embodiments of the disclosed subject matter, the polymeric hydrophilic bioplasticiser comprises poly(glycerol-citrate) (PGC). In further specific embodiments of the disclosed subject matter, poly(glycerol-citrate) is the product of the reaction whereby glycerol and citric acid are mixed in a 1:1 ratio by weight followed by heating at 150° C. with continuous stirring until the solution became very viscous and the excess water evaporated. In embodiments of the disclosed subject matter, the polymeric hydrophilic bioplasticiser is blended with the polypeptide-based biopolymer in any suitable ratio to generate a bioplastic film. In specific embodiments of the disclosed subject matter, the polymeric hydrophilic bioplasticiser is blended with the polypeptide-based biopolymer in a ratio by weight with respect to the itself and biopolymer of: at most 75 w/w %; at most 67 w/w %; at most 50 w/w %; at most 33 w/w %; at most 25 w/w %; or at most 20 w/w %; and at least 0.01 w/w %; wherein the polypeptide-based biopolymer is dissolved in water in a ratio by weight of: at most 1:10; at most 1:20; at most 1:30; at most 1:40; at most 1:50; at most 1:60; at most 1:70; at most 1:80; at most 1:90; at most 1:100. In a specific embodiment of the disclosed subject matter, the polymeric hydrophilic bioplasticiser comprises PGC. In a further specific embodiment of the disclosed subject matter, PGC is blended with the polypeptide-based biopolymer, wherein the polypeptide-based biopolymer comprises gelatine, in a ratio by weight of 3:1, wherein the gelatine is dissolved in water in a ratio by weight of 1.5:40.

In some instances, it may be desirable to include more than one bioplasticiser. In certain embodiments of the disclosed subject matter, the bioplasticiser may comprise one or more bioplasticisers. In certain embodiments of the disclosed subject matter, the bioplasticiser may comprise a mixture of at least one small molecule bioplasticiser and at least one polymeric bioplasticiser. In certain embodiments the small molecule bioplasticiser and the polymeric bioplasticiser may be combined in any ratio. In further embodiments of the disclosed subject matter, the small molecule bioplasticiser and the polymeric bioplasticiser are combined in a ratio by weight of: at most 5:1; at most 4:1; at most 3:1; at most 2:1; at most 1:1; at most 1:2; at most 1:3; at most 1:4; at most 1:5. In further embodiments of the disclosed subject matter, the small molecule bioplasticiser/polymeric bioplasticiser mixture is blended with the polypeptide-based biopolymer in a mixing ratio by weight of: at most 90 w/w %; at most 85 w/w %; at most 80 w/w %; at most 75 w/w %; at most 67 w/w %; at most 50 w/w %; at most 33 w/w %; at most 25 w/w %; at most 20 w/w %; at most 15 w/w %; or at most 10 w/w %; and at least 0.01 w/w %; wherein the polypeptide-based biopolymer is dissolved in water in a ratio by weight of: at most 1:10; at most 1:20; at most 1:30; at most 1:40; at most 1:50; at most 1:60; at most 1:70; at most 1:80; at most 1:90; at most 1:100. In specific embodiments of the disclosed subject matter, the small molecule bioplasticiser comprises TEC and/or the polymeric bioplasticiser comprises PGC. In a further specific embodiment TEC is mixed with PGC in a mixing ratio by weight of 1:2 and is blended with a polypeptide-based biopolymer, wherein the polypeptide-based biopolymer comprises gelatine, in a mixing ratio by weight of 2:1; wherein gelatine is dissolved in water in a mixing ratio by weight of 1.5:40.

The bioplastic films and composite materials of the presently disclosed subject matter comprise a coating that includes alpha-eleostearic acid as a major component. The term “major component” as used herein refers to the substance constituting greater than 50 wt % of the mass of the coating, suitably greater than 55 wt %; 60 wt %; 65 wt %; 70 wt %; 75 wt %; 80 wt %; and 85 wt % or more. Alpha-eleostearic acid is also known by the IUPAC name of (9Z,11E,13E)-octadeca-9,11,13-trienoic acid. It is a conjugated linolenic acid having three fully conjugated double bonds at positions 9, 11 and 13, in cis, trans and trans configurations, respectively. Alpha-eleostearic acid is a major constituent of tung oil and a significant component of bitter melon seed oil. Hence, according to embodiments of the presently disclosed subject matter, the coating may comprise tung oil and/or bitter melon seed oil or a derivative or combination thereof. Tung oil is obtained from the nuts of two species of trees, Aleurites fordii and Aleurites montana. Tung oil may be heated or boiled prior to use in order to enhance polymeric coating formation.

In some instances, it may be desirable to incorporate a sensory substance within the film, or coated on a first and/or second surface of the film or coated on one or more sections of a first and/or second surface of the film, for the detection of environmental changes, including but not limited to pH changes and microbial growth. Such properties are particularly advantageous for applications including packaging, such as food packaging, where an indication of change in pH or microbial growth is an important indication of the condition of a packaged item. For example, when food spoils, acid, such as lactic acid or acetic acid, may be generated, for example by bacteria, leading to a change in environmental pH. Detection of the change in pH or bacterial growth would serve as an indication that the food has spoiled and/or is unsafe to consume.

The current disclosed subject matter recognises the problem of food spoilage by providing embodiments wherein a bioplastic film comprises at least one sensor substance selected from the group consisting of: a pH sensor substance; a microbial sensor substance. In specific embodiments of the disclosed subject matter, the sensor substance is a pH sensor substance. In specific embodiments of the disclosed subject matter the pH sensor substance appears as a different colour within the visible spectrum of light at each of neutral pH (pH=7) and acidic pH (pH<7) and basic pH (pH>7). The bioplastic film comprising a pH indicator can therefore be used to visually detect changes in environmental pH which can in turn be an indicator of, for example, food spoilage. In specific embodiments of the disclosed subject matter the pH sensor substance is distributed throughout the bioplastic film or coated on the first or the first and second surface of the bioplastic film. In specific embodiments of the disclosed subject matter, the pH sensor substance is at least one pH indicator molecule. In further specific embodiments of the disclosed subject matter, the at least one pH indicator molecule is a pH indicator dye pigment. In further specific embodiments of the disclosed subject matter, the pH indicator dye pigment is a natural pH indicator dye pigment. In further specific embodiments of the disclosed subject matter, the pH indicator dye pigment is a natural pH indicator dye pigment and is safe for human and/or animal consumption. In further specific embodiments of the disclosed subject matter, the at least one natural pH indicator dye pigment is selected from the group of compounds, including but not limited to anthocyanins, betalains and curcuminoids.

In further specific embodiments of the disclosed subject matter, the natural pH indicator dye pigment is an anthocyanin or mixture of anthocyanins. In specific embodiments of the disclosed subject matter, the at least one natural pH dye indicator pigment may be extracted as a mixture of pigments from a natural source, including but not limited to berries, including but not limited to blueberries, raspberries, blackberries, chokeberries, mulberries, elderberries, strawberries, and lingonberries; cabbages, including but not limited to red cabbage; eggplant; beets; drupes, including but not limited to cherries, plums, peaches and nectarines; flowers, including but not limited to those of morning glories, petunias, primroses, roses, delphiniums, geraniums and peonies; onions; grapes; currants; cacti; carrots; cauliflower, including but not limited to purple cauliflower; plant roots, including but not limited to those of the genus curcuma; and punicae, including but not limited to pomegranate.

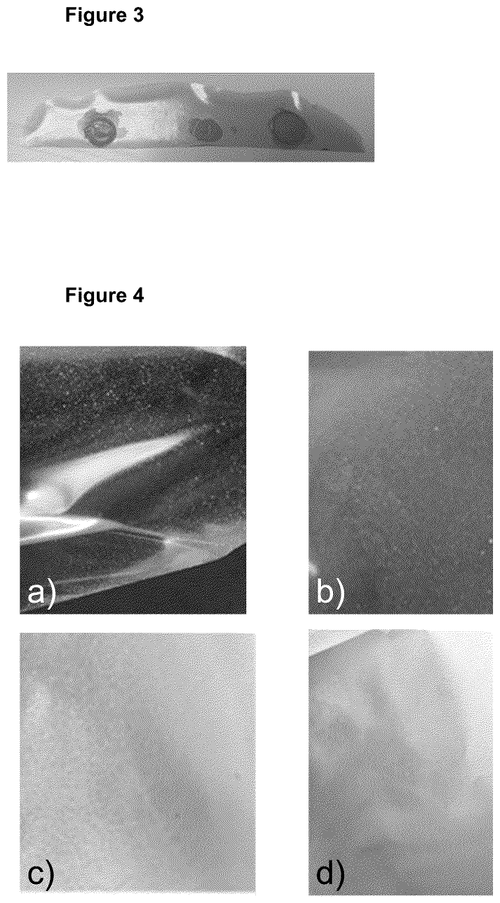

In certain embodiments of the disclosed subject matter, the at least one pH indicator dye pigment may be blended with the polypeptide-based biopolymer/bioplasticiser mixture before the bioplastic film is generated, in either a purified form or as an extract from a natural source. In certain specific embodiments of the disclosed subject matter, blueberries are used as a natural source of anthocyanins. In specific embodiments of the disclosed subject matter, blueberries are crushed such that anthocyanins are released from the skins of the blueberries, and the juice is collected as an anthocyanin extract. The blueberry juice is then blended with the polypeptide-based biopolymer/bioplasticiser mixture and the solution is neutralised using an aqueous base solution, optionally aqueous sodium hydroxide, optionally, 0.1 M aqueous sodium hydroxide, optionally 1 M aqueous sodium hydroxide; optionally 15 M aqueous sodium hydroxide; optionally any suitable concentration of aqueous sodium hydroxide. Different batches of extract from natural sources may contain varying amounts of different pH indicator dye pigments and therefore the amount of natural extract and/or bioplasticiser added to the polypeptide-based biopolymer aqueous solution will be variable requiring optimisation using standard techniques. In a specific embodiment of the disclosed subject matter, 1 g of PGC is added to 1.5 g of gelatine in deionised water (26 mL) at 40° C. and stirred until fully dissolved. Blueberry juice (4 mL), as anthocyanin extract, and aqueous sodium hydroxide (0.1 M; 12 mL) were then added to the polypeptide-based biopolymer/bioplasticiser aqueous solution. A film is then generated using the resulting solution. The resulting film is both transparent and flexible. Exposure of the bioplastic film to acidic pH conditions (pH<7) results in the film assuming a pink colour; while exposure of the film to basic pH conditions (pH>7) results in the film assuming a yellow colour as shown in FIG. 3. Optionally aqueous sodium hydroxide with a concentration of 1 M 15 M may also be used where the volumes of water used to make up the polypeptide-based biopolymer aqueous solution and volume of added aqueous sodium hydroxide are suitably adjusted.

The presently disclosed subject matter also recognises that in certain applications there may be a need to inhibit microbial growth, on or within to the packaging of certain perishable items. Such items may spoil because of unwanted microbial growth either during transport or storage. The compositions and method of embodiments of the disclosed subject matter provide a solution to this problem by providing a bioplastic film with antimicrobial properties. In some embodiments of the disclosed subject matter, it is desirable to blend an antimicrobial material or composition into the bioplastic film. In some embodiments of the disclosed subject matter, it is desirable to coat a first or a first and second surface of the bioplastic film with an antimicrobial material or composition. The surface that is coated may be a packaged product-facing surface of the film, and may, optionally, come into physical contact with the packaged product. The antimicrobial material may be any suitable agent for preventing microbial growth, including but not limited to diatomaceous earth, metallic nanoparticles, including but not limited to silver-containing nanoparticles, and immunoglobulins or mimetics thereof. In specific embodiments of the disclosed subject matter, the antimicrobial material or composition comprises diatomaceous earth. In further specific embodiments of the disclosed subject matter, diatomaceous earth is blended with the combined polypeptide-based biopolymer/bioplasticiser aqueous solution in a mixing ratio by weight of at most 3 w/w %, 2 w/w %, at most 1 w/w %, at most 0.5 w/w %, or at most 0.05 w/w % and at least 0.001 w/w %, optionally wherein the combined polypeptide-based biopolymer/bioplasticiser aqueous solution may further comprise a sensor substance. The resulting aqueous solution comprising a polypeptide-based biopolymer, bioplasticiser and diatomaceous earth, and optionally sensor substance, is then used to generate a film with antimicrobial properties, as shown in Table 4, optionally with the said sensor properties.

Whilst biodegradable packaging articles are known, in some instances they degrade too quickly to fulfil their intended purpose, such as to act as durable and effective packaging for food or pharmaceutical items. Furthermore, they may not provide adequate barrier protection to a packaged item against air or gasses, water and/or moisture. The presently disclosed subject matter addresses this problem by providing a composite material comprised of a bioplastic film and a coating. In addition to the coating that includes alpha-eleostearic acid as a major component, as described herein, the composite materials may be coated with a further hydrophobic substance applied either to the first surface or the first and the second surface of the bioplastic film, which imparts improved barrier properties to the bioplastic film against water and/or moisture and/or gases.

The coating may be applied to the bioplastic film by any suitable method, including but not limited to dip coating or spray coating, followed by drying using any suitable method, including but not limited to air-drying or oven-drying at any suitable temperature. As mentioned previously, the coating will comprise alpha-eleostearic acid as a major component, suitably in the form of tung oil, a bitter melon seed oil or a derivative thereof. An additional hydrophobic coating may comprise any appropriate hydrophobic, biocompatible, biodegradable and/or compostable wax, oil or resin of organic or synthetic origin, including but not limited to beeswax, carnauba oil, linseed oil, or shellac. Carnuba wax is often used within the food industry to coat the inside of cups and food containers. Beeswax is used as a water barrier in many different types of industries, including cosmetics and clothing. Linseed oil is extracted from dried seeds of flax plants and commonly used as a natural alternative to polyurethane. Shellac is a resin of insect origin and used, amongst other uses, as a food glaze and wood finish. It will be appreciated that other animal, vegetable, microbial or nut-derived non-toxic oils, waxes or resins may be used to impart a hydrophobic coating or finish to a surface of a bioplastic film according to embodiments of the presently disclosed subject matter.

In other embodiments the disclosed subject matter provides an alternative method to improve the mechanical properties and hydrophobicity of the bioplastic film by UV light-induced crosslinking of the component polypeptide strands. Exposure of bioplastic films of the disclosed subject matter to UVC (254 nm) and UVB (336 nm) light for different time intervals (0-120 minutes) can improve their hydrophobicity, as measured using contact angle measurements using a goniometer.

The bioplastic film of any embodiment described herein may be used as a packaging film for any suitable purpose. Such a purpose may be for packaging a perishable item, which may be food, chemicals, pharmaceuticals, plants or animal products. The perishable item may be a food item. The food item may be one or more of a single item such as meat, poultry, fruits, vegetables, or seafood or comprise more than one item in any combination. The food item may be fish, including but not limited to cod, salmon, halibut, tilapia, haddock, sole, perch, walleye, tuna, catfish, bream, barramundi, trout, bluefish, grouper, branzino, snapper, swordfish, mackerel, sardines, herring, or anchovies. The item may be a whole fish, or a fish portion, including, for example, a fish fillet. The item may be any other food item, including one or more raw food items or one or more cooked food items. The food item may be a prepared food item. The food item may be a prepared food item which is ready-to-eat or a prepared food item which may require further cooking or heating. The food item may be a sandwich or sandwiches. The packaging may exclusively comprise the bioplastic film, or the bioplastic film may be one component of the packaging. The bioplastic film, or one or more sections of the bioplastic film, may be capable of indicating a change in environmental pH. The bioplastic film may be capable of inhibiting microbial growth on a perishable item or non-perishable item. The bioplastic film may be capable of indicating a change in environmental pH and inhibiting microbial growth on a perishable item or non-perishable item. The packaging may be for a sterile item. The sterile item may be one or more pieces of medical equipment or implements. The medical equipment or implements may be for use in a sterile setting, such as surgical equipment. The medical equipment or implement may be a first aid item, including but not limited to a band aid or plaster, sterile cleansing wipe, bandage, gauze, eye dressing, gloves, tweezers, scissors, sticky tape, thermometer, suture, or medicaments and pharmaceuticals.

Without wishing to be bound by theory, evidence suggests that while the pH of human and/or animal wounds is not sufficiently understood to be translated into a precise metric for infection, the pH scale has been demonstrated to have potential to act as a diagnostic and management indicator for infection. Whilst further understanding of the complex interplay between parameters including bacteria profile and healing cascade is helpful to further understand how pH may be used to determine treatment pathways, for example using antibiotics, research nonetheless indicates that alkaline pH is conducive to bacterial infection. The presently disclosed subject matter recognises this issue and provides a solution in embodiments where the bioplastic film of any preceding embodiment may be used as a coating for sterile medical dressings including but not limited to bandages, sutures, gauze dressings and band aids or plasters. In further specific embodiments of the disclosed subject matter, the bioplastic film comprising a pH sensor substance may be used as a coating for sterile medical dressings, including but not limited to, bandages, gauze dressings, sutures, Steri-Strips™, and band aids or plasters which are able to indicate changes in environmental pH when applied to a human or animal wound to enable detection of wound infection. In further specific embodiments of the disclosed subject matter, the bioplastic film coating the sterile medical dressing may comprise a pH sensor substance either distributed throughout the bioplastic film the bioplastic film or coated on the first or the first and second surface of the bioplastic film and comprises at least one anthocyanin, betalain or curcuminoid. In specific embodiments of the disclosed subject matter, the bioplastic film comprising an antimicrobial material or composition may be used as a coating for sterile medical dressings including but not limited to bandages, gauze dressings and band aids or plasters, which are able to inhibit microbial growth and infection when applied to a human or animal wound. In further specific embodiments of the disclosed subject matter, the bioplastic film coating the sterile medical dressing may comprise an antimicrobial composition or substance either distributed throughout the bioplastic film or coated on the first or the first and second surface of the bioplastic film. In further specific embodiments of the disclosed subject matter, the bioplastic film comprising a pH sensor substance and an antimicrobial material or composition may be used as a coating for sterile medical dressings including but not limited to bandages, gauze dressings and band aids or plasters. In further embodiments of the disclosed subject matter, the film comprising the pH sensor substance and/or microbial sensor substance and/or antimicrobial material or composition may be applied to the sterile medical dressing by any suitable method including by spraying.

Many forms of polymer films are able to act as ink-printable substrates, for example where plastic films are used for packaging, to enable the display of branding or for product information relating to its contents. Furthermore, plastic substrates are often used for electronic circuits, such as flexible electronics and single-use electronics, including sensors, which may include antennae for tagging product items, including for example RFID antennae, which may be printed on the films either horizontally or vertically and contains product information. In embodiments of the disclosed subject matter, the first or the first and second surface of the bioplastic film provides an ink-printable substrate. In specific embodiments the ink is a biodegradable and/or compostable ink. In specific embodiments the ink is a biodegradable and/or compostable water-soluble ink. In further specific embodiments the ink a carbon-based ink. Such embodiments facilitate the realisation of biodegradable and/or compostable packaging where branding or labelling information may be printed directly onto the packaging, replacing conventional packaging for complete recyclability. In other embodiments, the ink is a conductive ink. In further embodiments the ink is a water non-soluble ink. In further embodiments the ink is a silver-based ink. In yet further embodiments the ink is a water non-soluble, silver-based ink. Such embodiments may comprise easily recyclable electronic circuits or single use electronic circuits or components of recyclable electronic circuits.

Bubble wrap is a common form of plastic packaging used to wrap fragile items for protection during storage or transportation. Bubble wrap is made most commonly using plastics such as polyethylene, which takes over 500 years to decompose. The current disclosed subject matter recognises this problem and provides a solution in some embodiments in the form of a bioplastic protective packaging that comprises the composite material. In embodiments of the disclosed subject matter the bioplastic protective packaging is a bioplastic protective bubble wrap. In embodiments of the disclosed subject matter the bioplastic protective packaging may be generated by any suitable method. In specific embodiments of the disclosed subject matter, the bioplastic protective packaging may be generated using any suitable three-dimensional mould to generate a bioplastic film with numerous dome-like features throughout. Such dome-like features may be distinct or interconnected as demonstrated in FIG. 11. In further specific embodiments the bioplastic film with such three-dimensional dome-like features is a bioplastic protective packaging and may be used as such. In further embodiments of the disclosed subject matter, at least two such dome-featured films may be adhered together, for example by heat-sealing, to generate a bioplastic bubble wrap, which contains air pockets distributed throughout the bubble wrap. In further embodiments of the disclosed subject matter, the bubble wrap may incorporate all features of previously disclosed embodiments above.

The disclosed subject matter is further illustrated by reference to the following non-limiting examples.

### EXAMPLES

### Example 1: Bioplastic Film Synthesis Using Triethylcitrate (TEC)

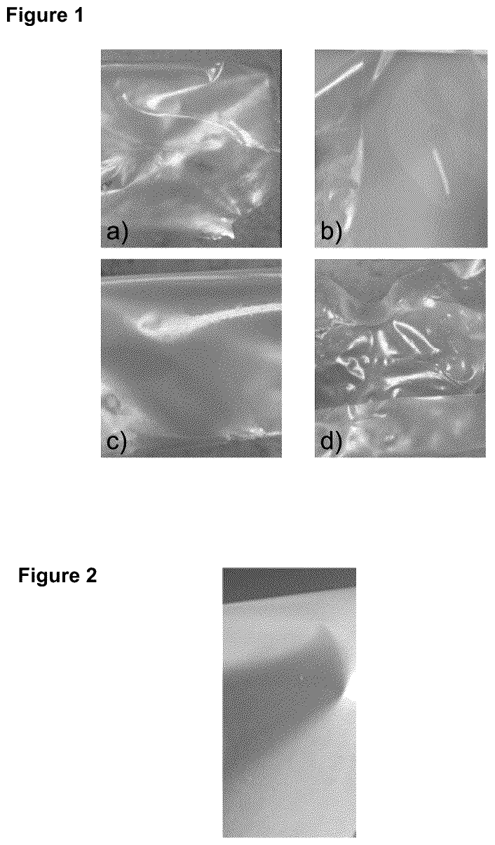

Different solutions containing 1.5 g gelatine dissolved in 40 mL deionised water at 40° C. were made. The solutions were stirred for 10 minutes until all the gelatine had dissolved. Different weight percent (w/w %) amounts of triethylcitrate (TEC) (between 0.1 w/w % to 25 w/w %; relative to gelatine) were then added to the gelatine solutions as shown in Table 1. The solutions were then poured onto a substrate and dried naturally overnight. The bioplastic films were then peeled off the substrate. The thickness of the bioplastic films was measured (Mitutoyo, No. 239-812) to be approximately 58 μm. Table 1 shows a summary of the results (also see FIG. 1).

TABLE 1
The effect of TEC on bioplastic film synthesis.

| | Gelatine | Water | TEC | Observation/ |
|---|---|---|---|---|
| Formulation | (g) | (ml) | (mL/g) | Corresponding Figure |
| 1.1 | 1.5 | 40 | 0.04/0.05 | Flexible; transparent; forms a crease |
| | | | | when folded/FIG. 1a |
| 1.2 | 1.5 | 40 | 0.20/0.23 | Flexible; transparent/FIG. 1b |
| 1.3 | 1.5 | 40 | 0.40/0.45 | Expelled some oil; flexible; semi- |
| | | | | transparent/FIG. 1c |
| 1.4 | 1.5 | 40 | 2.10/2.39 | Expelled some oil; flexible; semi- |
| | | | | transparent/FIG. 1d |

### Example 2: Bioplastic Film Synthesis Using Poly(Glycerol-Citrate) (PGC)

Different solutions containing 1 g gelatine dissolved in different amounts of deionised water at 40° C. were made. The solutions were stirred for 10 minutes until all the gelatine was dissolved. Varying amounts of PGC were then added to the solutions and the mixtures were stirred for 15 minutes at 40° C. The solutions were then poured onto a substrate and dried naturally overnight. The bioplastic films were then peeled off the substrate. Table 2 shows the results.

Poly(glycerol-citrate) (PCG) was synthesised by mixing 15 g glycerol and 15 g citric acid and heating the mixture at 150° C. with continuous stirring for approximately 2 hours, until the solution had become very viscous, and the excess water had evaporated.

The skilled person would also understand that poly(glycerol-citrate) may also be synthesised using other ratios of glycerol to citric acid to generate PGC of other molecular weights and polydispersity indices. According to other embodiments of the disclosed subject matter the glycerol:citric acid ratio used to generate PGC may be: 4:1; or 3:1; or 2:1; or 1:2; or 1:3; or 1:4; or any ratio generating PGC which be a suitable bioplasticer.

TABLE 2
The effect of PGC on bioplastic film synthesis.

| | Gelatine | Water | PGC | Observation/ |
|---|---|---|---|---|
| Formulation | (g) | (ml) | (g) | Corresponding Figure |
| 2.1 | 1 | 50 | 0.25 | Crease forms after bending. |
| 2.2 | 1 | 30 | 0.25 | Less creases than formulation 2.1. |
| 2.3 | 1 | 40 | 0.35 | Very soft no creases after bending. |
| 2.4 | 1 | 40 | 3 | Appears and feels like a clear plastic bag. |

### Example 3: Bioplastic Film Synthesis Using Triethylcitrate (TEC) and Poly(Glycerol-Citrate) (PGC)

1.5 g gelatine was added to 40 mL deionised water at 40° C. The mixture was stirred for 10 minutes until all the gelatine was dissolved. 1 g TEC and 2 g PGC were added to gelatine solution. The solution was then poured onto a substrate and dried naturally overnight. The bioplastic films were then peeled off the substrate. Table 3 shows the results.

TABLE 3
The effect of TEC and PGC on bioplastic film synthesis.

| | Gelatine | Water | TEC | PGC | Observation/ |
|---|---|---|---|---|---|
| Formulation | (g) | (ml) | (g) | (g) | Corresponding Figure |
| 3.1 | 1.5 | 40 | 1.0 | 2.0 | Flexible; translucent/ |
| | | | | | FIG. 2 |

### Example 4: Antimicrobial Film Synthesis Using Diatomaceous Earth

Different solutions containing 1.5 g gelatine dissolved in 40 mL deionised water at 40° C. were made. The solutions were stirred for 10 minutes until all the gelatine had dissolved. Different amounts of either Triethylcitrate (TEC) or Poly(glycerol citrate) (PGC) were then added to the gelatine solutions as shown in Table 4. Varying amounts (weight percent, w/w %) of diatomaceous earth were added to the solutions and the mixtures were then poured onto a substrate and dried naturally overnight. The bioplastic films were then peeled off the substrate. Table 4 shows a summary of the results. As the amount of added diatomaceous earth increases above 0.5 w/w % the transparency of the films decreases. Further addition of diatomaceous earth above 1 w/w % leads to reduced film transparency, agglomeration of the diatomaceous earth and brittleness and cracking of the film. Optimum film composition was found to comprise or consist of 0.05 w/w % diatomaceous earth.

TABLE 4
The effect of diatomaceous earth (diatom) on bioplastic film synthesis.

| | | | | | Diatom | |
|---|---|---|---|---|---|---|
| | Gelatine | Water | TEC | PGC | (g/ | Observation/Corresponding |
| Formulation | (g) | (ml) | (mL) | (g) | w/w %) | FIG. |
| 4.1 | 1.5 | 40 | 0 | 1.0 | 0.025/ | Flexible; grainy at the top side; |
| | | | | | 0.05 | transparent/FIG. 4a |
| 4.2 | 1.5 | 40 | 0.2 | 0 | 0.0253/ | Flexible; grainy at the top side; |
| | | | | | 0.05 | transparent/FIG. 4b |
| 4.3 | 1.5 | 40 | 0.2 | 0 | 0.25/ | Flexible; grainy at the top side; |
| | | | | | 0.5 | transparent/FIG. 4c |
| 4.4 | 1.5 | 40 | 0.2 | 0 | 0.25/ | Flexible; grainy at the top side; |
| | | | | | 1 | translucent; some of Diatomite |
| | | | | | | particles precipitated out of |
| | | | | | | solution/FIG. 4d |

### Example 5: pH Sensor Bioplastic Film Synthesis

Gelatine (1.5 g) was dissolved in deionised water 26 mL at 40° C. were made. The solutions were stirred for 10 minutes until all the gelatine had dissolved. PGC (1 g) and blueberry juice (4 mL) was added to the solutions, which were then neutralised by the addition of 0.1 M aqueous sodium hydroxide (12 mL). The solutions were then poured onto a substrate and dried naturally overnight. The bioplastic films were then peeled off the substrate. The effect of exposure to both acid and base is demonstrated in FIG. 3.

TABLE 5.1
pH sensitive bioplastic film generation.

| | | | | Blueberry | Sodium | |
|---|---|---|---|---|---|---|
| | Gelatine | Water | PGC | Juice | Hydroxide | |
| Formulation | (g) | (ml) | (g) | (ml) | (aq; 0.1M) | Observation |
| 5.1 | 1.5 | 26 | 1 | 4 | 12 mL | Transparent and |
| | | | | | | flexible |

Blueberry juice containing anthocyanins was prepared by crushing 250 g of blueberries in a pestle and mortar. The crushed berries were added to a 60 mL: 40 mL methanol: deionised water solution, which was then sonicated at 35° C. for 30 minutes. The mixture was then centrifuged, and the supernatant decanted to remove solid impurities and stirred overnight at 30° C. The concentration of anthocyanin in the extract was determined by buffered pH titration and UV-vis spectrometry as 368 mg/ml (0.82 M).

Methods used to create buffer solution outlined by Lee et al. Journal of AOAC International, Vol. 88, No. 5, 1269-1278.
(a) pH 1.0 buffer (potassium chloride, 0.025M). Weigh 1.86 g KCl into a beaker and add distilled water to ca 980 mL. Measure the pH, and adjust pH to 1.0 (±0.05) with HCl (ca 6.3 mL). Transfer to a 1 L volumetric flask, and dilute to volume with distilled water.
(b) pH 4.5 buffer (sodium acetate, 0.4M). Weigh 54.43 g CH3CO₂Na·3H2O in a beaker, and add distilled water to ca 960 mL. Measure the pH, and adjust pH to 4.5 (±0.05) with HCl (ca 20 mL). Transfer to a 1 L volumetric flask, and dilute to volume with distilled water

TABLE 5.2
Absorbance values of anthocyanin.

| pH | 520 nm | 700 nm |
|---|---|---|
| 4.5 | 0.2025 | 0.101 |
| 1.0 | 0.6138 | 0.0704 |

Anthocyanin concentration was calculated using the equation below:

$$anthocyanin concentration = \frac{A \times MW \times DF \times {10}^{3}}{ε \times I}$$

$$Where :$$

$$A = ( A 520 - A 700 ) pH 1 - ( A 520 - A 700 ) pH 4.5 = ( 0.6138 - 0.0704 ) - ( 0.2025 - 0.101 ) = 0.4419$$

$$MW = 449.2 g / mol$$

$$DF = Dilution factor$$

$$I = Path length cm$$

$$ε = 26900 L / mol cm$$

$${10}^{3} = conversion factor$$

$$A nthocyanin = \frac{0.4419 \times 449.2 \times 50 \times {10}^{3}}{26900 \times 1}$$

$$A nthocyanin = 368 mg / ml$$

UV-Vis absorbance values for anthocyanin response at pH 4.5 is presented at Table 5.2 and depicted in FIG. 13.

TABLE 5.3
UV-Vis absorbance values for anthocyanin response at pH 4.5.

| nm | A |
|---|---|
| 800 | 0.0857 |
| 798 | 0.0858 |
| 796 | 0.0864 |
| 794 | 0.0859 |
| 792 | 0.0862 |
| 790 | 0.088 |
| 788 | 0.0871 |
| 786 | 0.0891 |
| 784 | 0.0883 |
| 782 | 0.0895 |
| 780 | 0.0899 |
| 778 | 0.0898 |
| 776 | 0.09 |
| 774 | 0.0914 |
| 772 | 0.0915 |
| 770 | 0.0915 |
| 768 | 0.0918 |
| 766 | 0.0928 |
| 764 | 0.0936 |
| 762 | 0.0937 |
| 760 | 0.0941 |
| 758 | 0.0952 |
| 756 | 0.0956 |
| 754 | 0.0962 |
| 752 | 0.0963 |
| 750 | 0.0964 |
| 748 | 0.0973 |
| 746 | 0.0982 |
| 744 | 0.0991 |
| 742 | 0.1 |
| 740 | 0.1 |
| 738 | 0.1004 |
| 736 | 0.1017 |
| 734 | 0.1021 |
| 732 | 0.103 |
| 730 | 0.1033 |
| 728 | 0.1045 |
| 726 | 0.1052 |
| 724 | 0.1057 |
| 722 | 0.1064 |
| 720 | 0.1075 |
| 718 | 0.1089 |
| 716 | 0.1093 |
| 714 | 0.1105 |
| 712 | 0.1108 |
| 710 | 0.1114 |
| 708 | 0.113 |
| 706 | 0.1141 |
| 704 | 0.1149 |
| 702 | 0.1155 |
| 700 | 0.1165 |
| 698 | 0.1172 |
| 696 | 0.1186 |
| 694 | 0.1197 |
| 692 | 0.1206 |
| 690 | 0.1217 |
| 688 | 0.1227 |
| 686 | 0.1233 |
| 684 | 0.1247 |
| 682 | 0.1253 |
| 680 | 0.1267 |
| 678 | 0.1279 |
| 676 | 0.1294 |
| 674 | 0.1308 |
| 672 | 0.1325 |
| 670 | 0.1339 |
| 668 | 0.1354 |
| 666 | 0.1371 |
| 664 | 0.1383 |
| 662 | 0.1402 |
| 660 | 0.1419 |
| 658 | 0.1439 |
| 656 | 0.1459 |
| 654 | 0.1478 |
| 652 | 0.1498 |
| 650 | 0.1518 |
| 648 | 0.1535 |
| 646 | 0.1553 |
| 644 | 0.1574 |
| 642 | 0.1598 |
| 640 | 0.1619 |
| 638 | 0.1636 |
| 636 | 0.1657 |
| 634 | 0.168 |
| 632 | 0.17 |
| 630 | 0.1715 |
| 628 | 0.1734 |
| 626 | 0.175 |
| 624 | 0.1767 |
| 622 | 0.1785 |
| 620 | 0.1801 |
| 618 | 0.1811 |
| 616 | 0.1828 |
| 614 | 0.1844 |
| 612 | 0.1852 |
| 610 | 0.1868 |
| 608 | 0.1881 |
| 606 | 0.189 |
| 604 | 0.1903 |
| 602 | 0.1916 |
| 600 | 0.1928 |
| 598 | 0.1937 |
| 596 | 0.1949 |
| 594 | 0.196 |
| 592 | 0.1971 |
| 590 | 0.1984 |
| 588 | 0.1994 |
| 586 | 0.2003 |
| 584 | 0.2012 |
| 582 | 0.2022 |
| 580 | 0.2032 |
| 578 | 0.204 |
| 576 | 0.2048 |
| 574 | 0.2055 |
| 572 | 0.206 |
| 570 | 0.2069 |
| 568 | 0.2074 |
| 566 | 0.2076 |
| 564 | 0.2081 |
| 562 | 0.2088 |
| 560 | 0.2092 |
| 558 | 0.2097 |
| 556 | 0.21 |
| 554 | 0.2105 |
| 552 | 0.211 |
| 550 | 0.2114 |
| 548 | 0.2116 |
| 546 | 0.2121 |
| 544 | 0.2127 |
| 542 | 0.2134 |
| 540 | 0.2139 |
| 538 | 0.2146 |
| 536 | 0.2152 |
| 534 | 0.2158 |
| 532 | 0.2165 |
| 530 | 0.2172 |
| 528 | 0.2178 |
| 526 | 0.2184 |
| 524 | 0.2192 |
| 522 | 0.2197 |
| 520 | 0.2203 |
| 518 | 0.2209 |
| 516 | 0.2215 |
| 514 | 0.222 |
| 512 | 0.2227 |
| 510 | 0.2234 |
| 508 | 0.2241 |
| 506 | 0.2247 |
| 504 | 0.2252 |
| 502 | 0.2259 |
| 500 | 0.2267 |
| 498 | 0.2272 |
| 496 | 0.2274 |
| 494 | 0.228 |
| 492 | 0.2284 |
| 490 | 0.2287 |
| 488 | 0.2289 |
| 486 | 0.2293 |
| 484 | 0.23 |
| 482 | 0.2301 |
| 480 | 0.2303 |
| 478 | 0.2311 |
| 476 | 0.2319 |
| 474 | 0.2327 |
| 472 | 0.2335 |
| 470 | 0.2344 |
| 468 | 0.2354 |
| 466 | 0.2365 |
| 464 | 0.2377 |
| 462 | 0.2388 |
| 460 | 0.2398 |
| 458 | 0.2409 |
| 456 | 0.2421 |
| 454 | 0.2432 |
| 452 | 0.2443 |
| 450 | 0.2455 |

### Example 6: Effect of Bioplastic Film Coating with Hydrophobic Waxes and Oils to Form a Composite Material

Sample bioplastic films comprising gelatine and either TEC (1.5 g of gelatine, 0.2 mL TEC in 40 mL deionised water) or PGC (1.5 g of gelatine, 1 g PGC in 40 mL deionised water) were generated and coated with different waxes and oils; firstly by the dip coating method, whereby the films were completely immersed in a bath of the oil or wax. Upon coating with carnuba oil, the hydrophobic layer solidified quickly forming a rigid coat which flaked off when bent. When coated with beeswax, the flexibility of the film was unaffected, however, the film's transparency was reduced. Dip coating the films in tung oil and linseed oil did not impact the transparency of the film, although the coating was not uniform.

Spray coating the films generated with either TEC or PGC bioplasticisers using tung oil or linseed oil was then demonstrated using an airbrush gun and associated pump (Sealy Air brush kit, model AB931.V2; and Smart Jet pro air compressor iwata studio series). Spray coating of the pure oils and oils diluted with isopropanol in a 1:2 ratio was demonstrated. Three spray coatings were found to be sufficient to cover the films' surfaces. Optimum results were observed, achieving uniform spray coating, when the oils were diluted with isopropanol. Considering transparency and flexibility of the resulting films, tung oil gave the best results.

Further demonstrations to show the effectiveness of the hydrophobic coatings were performed. Three rectangular film samples (Formulation 1.2) of dimensions 4 cm×2 cm from spray-coated and non-coated films were cut and weighed. Each sample was then immersed in deionised water for 5 minutes, gently patted dry, and reweighed. The hydrophobicity parameter (% hydrophobicity) was then calculated using the following formula:

$$\% Hydrophobicity = [ \frac{{W}_{1} - {W}_{2}}{{W}_{1}} ] \times 100$$

Where W₁ is the weight of the water gained by the uncoated sample which had an average value of 0.228 g and W₂ is the weight of water gained by the coated sample. The results are described in Table 6.

TABLE 6
Calculation of the hydrophobic parameter (% hydrophobicity) for
bioplastic film samples spray-coated in tung and linseed oils.

| | | | | | % |
|---|---|---|---|---|---|
| | Sample | Dry weight | Wet | % | Hydrophobicity |
| Sample | number | (g) | weight (g) | Hydrophobicity | (average) |
| Tung oil coated | 1 | 0.058 | 0.066 | 96.35 | |
| (both sides) | | | | | |
| | 2 | 0.053 | 0.055 | 98.98 | 97.66 |
| | 3 | 0.051 | 0.056 | 97.66 | |
| Tung oil coated | 1 | 0.051 | 0.072 | 90.66 | |
| (one sides) | | | | | |
| | 2 | 0.049 | 0.100 | 77.52 | 73.58 |
| | 3 | 0.420 | 0.150 | 52.55 | |
| Linseed oil | 1 | 0.037 | 0.0549 | 92.01 | |
| coated (both | | | | | |
| sides) | | | | | |
| | 2 | 0.045 | 0.060 | 93.28 | 93.45 |
| | 3 | 0.049 | 0.060 | 95.04 | |
| Linseed oil | 1 | 0.049 | 0.127 | 65.69 | |
| coated (one | | | | | |
| sides) | | | | | |
| | 2 | 0.050 | 0.200 | 34.16 | 49.05 |
| | 3 | 0.050 | 0.170 | 47.30 | |

### Example 7: Ink Printing on Bioplastic Films

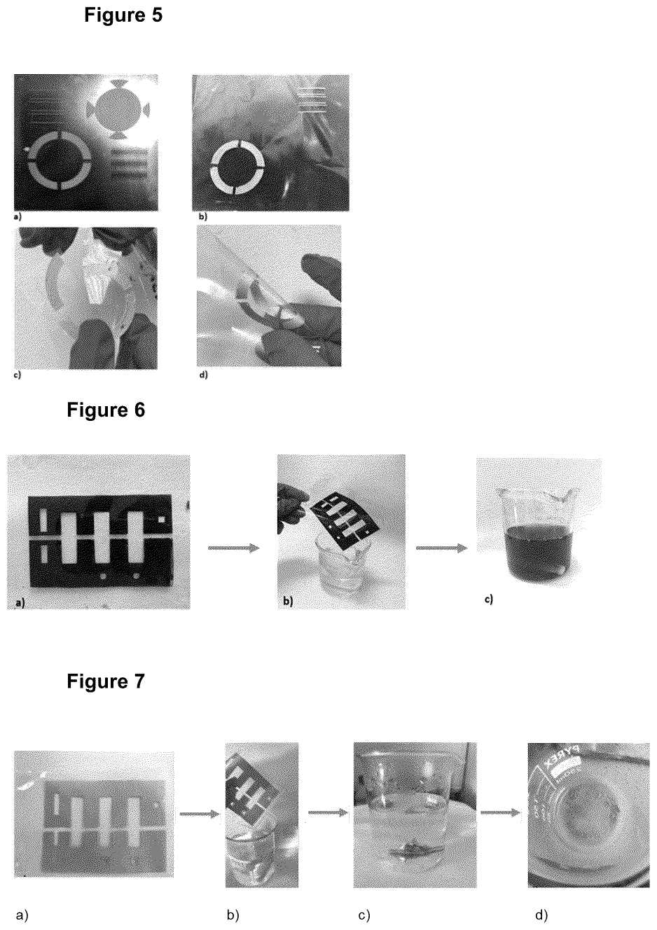

Bioplastic films were generated using TEC bioplasticiser (Formulation 1.2) as described above. A commercial silver paste was screen printed on the films using a stencil as shown in FIG. 5. The films were then heated at 80° C. for 15 minutes in an oven. Upon removal from the oven, the flexibility of the bioplastic films was evaluated by bending and folding of each sample. It was observed that the PGC film became rigid and broke upon bending, whereas the TEC film maintained its flexibility. A lower curing temperature of 65° C. was demonstrated after which both films maintained their flexibility. The conductivity of the inks on the bioplastic film substrates was then measured using an ohmmeter (Amprobe; Model: AM-510-EUR). The resistance of the inks was found to be on the order of 4.0Ω.

Ink printing of commercial conductive silver inks (inhouse formulation containing 15-25% silver particles) and carbon inks (Creative Materials, 124-43; Carbon filled, waterborne, low V.O.C., Flexographic, conductive ink and coating) on the bioplastic films using a flexographic printer (RK print coat instruments Ltd; Model: Flexiproof 100) was then investigated as shown in FIG. 7. The carbon ink is a water-based ink. Upon printing and curing, the bioplastic films maintained their flexibility. The resistance of the printed inks on the bioplastic film substrate was measured and found to be on the order of 315.4Ω. Upon immersion of the printed bioplastic films in water, the carbon inks dissolved. The silver-based ink contains an organic polymer binding and is not water-soluble. The resistance of the silver-based ink printed on the bioplastic film substrate was measured using the four-probe method (Jandel model RM3000+).

The sheet resistance and the resistivity of the silver ink printed on the biofilm was found to be 18.5 mΩ/square and 5.5×10−8 mΩ/m², respectively. Upon submersion of the silver ink-printed bioplastic film in water, the bioplastic film dissolved, and the silver ink settled at the bottom of the water bath, as shown in FIG. 7. Decanting the water and addition of acetone to the remaining solid facilitated dissolution of the organic binder leaving silver particles which could then be isolated by filtration and washing with acetone and recycled.

The sheet resistance and resistivity of the printed silver ink on the bioplastic film (43 μm film thickness; 18.5 mΩ/square and 5.5×10−8 mΩ/m²) were found to be similar to the same ink printed on a polyethylene terephthalate (PET) film (80 μm thickness; 15 m²/square and 4.5×10−8 mΩ m⁻²; also measured using the four-probe method), demonstrating the potential of the disclosed subject matter to be used as a replacement substrate for PET film in recyclable single use electronic application.

### Example 8. Tensile Strength Measurements

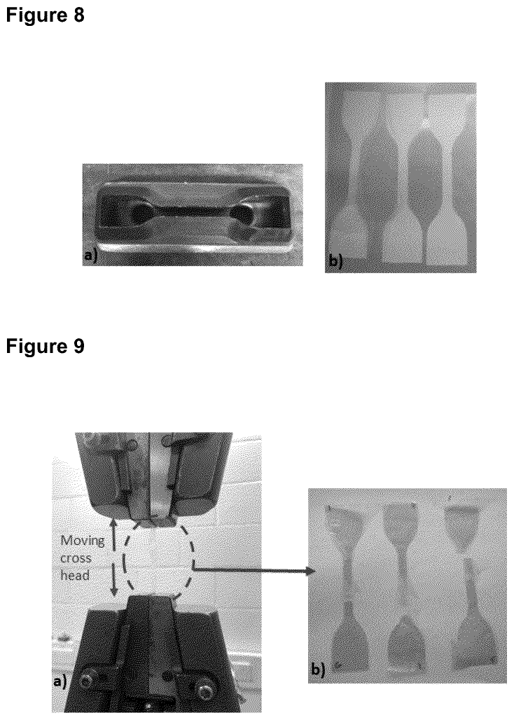

The structural integrity of the bioplastic films (Formulation 1.2) was demonstrated by measuring their tensile strengths using a universal testing machine (Zwick Roell Universal testing machine; Model: Zwick 1484; load cell 200 KN) as shown in FIG. 8a. Each bioplastic film testing sample was cut into the appropriate shape, as shown in FIG. 8c, with dimensions of length×breadth, 11.5 cm×2.5 cm. The samples were then held in the two grips of the machine as shown in FIG. 9b and stretched to breaking point. The average of three samples was used to calculate the average break point force. The bioplastic films of the disclosed subject matter were then compared to commercially available films (commercially available envelope films, such as polystyrene film). The results are summarised in Table 8. It was found that the bioplastic films of the disclosed subject matter displayed greater tensile strength than commercially available samples with the same thickness. Furthermore, coating the films with a hydrophobic coating (tung oil by the spray coating method described above) was found to improve the tensile strength of the bioplastic film. It was noted that upon coating with linseed oil, the bioplastic film became sticky, and measurement of the tensile strength may not represent its true value.

TABLE 7
Results of tensile strength measurements on various
bioplastic films and commercial films.

| | | Thickness | Average Break |
|---|---|---|---|
| Sample | Formulation | (μm) | point Force (N) |
| Gelatine and TEC bioplastic film | 1.2 | 43 | 10.361 |
| Commercial film from envelope 1 | — | 43 | 2.096 |
| Commercial film from envelope 2 | — | 44 | 6.985 |
| Gelatine and PGC:TEC (2:1) bioplastic | 3.1 | 77 | 10.200 |
| film | | | |
| Tung oil coated bioplastic film (both | 1.2 | 70 | 11.176 |
| sides) | | | |
| Linseed oil coated bioplastic film (both | 1.2 | 58 | 5.239 |
| sides) | | | |

### Example 9. Bubble Wrap

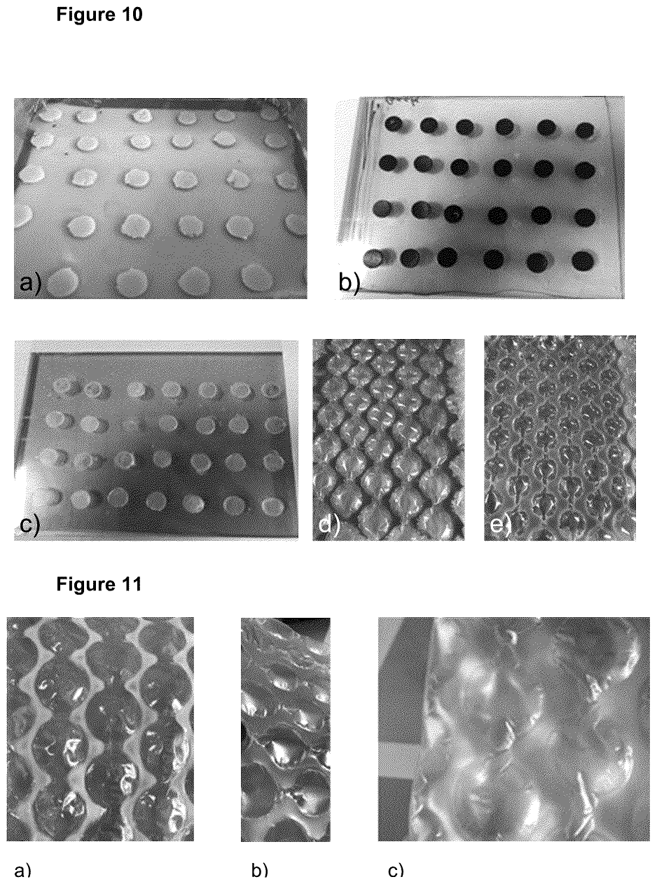

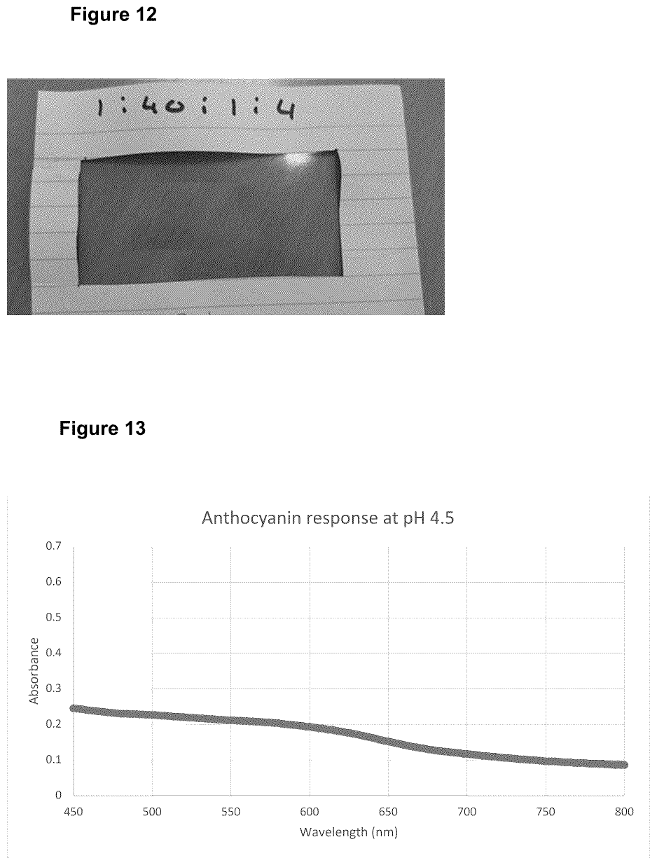

The use of the bioplastic film in a bubble wrap product was demonstrated. A series of different three-dimensional moulds were made and tested, as shown in Table 8, and corresponding FIG. 10. Each mould has the capacity to provide one bioplastic film constituting one half of a sheet of bubble wrap. Two such bioplastic films were then heat-sealed together to generate a single piece of bubble wrap.

100 mL of gelatine/bioplasticiser solution (6 g of gelatine, 0.6 mL TEC, 120 mL water) was poured into each mould and allowed to dry at room temperature for 48 hours. Certain moulds facilitated more easily peelable films than others as detailed in Table 9. A mould comprising or consisting of a combination of commercial bubble wrap and semi-hard silicone rubber (entry No. 5, Table 9.) gave the best results (FIG. 11). By varying the volume of gelatine/bioplasticiser solution poured into the mould, the thickness and flexibility of the resulting bubble wrap could be modulated.

TABLE 8
Examples of bioplastic bubble wraps moulds and generated bubble wrap films.

| Entry | | Observation/ |
|---|---|---|
| No. | Mould Composition | Corresponding Figure |
| 1 | Semi hard silicone rubber | Difficult to peel off the film from the |
| | | mould/FIG. 10a. |
| 2 | Silicone discs of 1-cm diameter and | Difficult to peel off the film from the |
| | 1.44-mm height were glued to a flat | mould/FIG. 10b. |
| | acrylic sheet and were evenly | |
| | spaced out to mimic air bubbles. | |
| 3 | Silicone discs of 1 cm diameter and | Difficult to peel off the film from the |
| | 2.88 mm height were glued a flat | mould/FIG. 10c. |
| | acrylic sheet and were evenly | |
| | spaced out to mimic air bubbles. | |
| 4 | Mixture of soft silicone rubber and | Easy to remove the film from the |
| | commercial bubble wrap. | mould. However, due to the soft nature |
| | | of silicone, some of it attached to the |
| | | film during its removal from the mould/ |
| | | FIG. 10d. |
| 5 | Mixture of semi-hard silicone | Easy to remove the film from the mould/ |
| | rubber and commercial bubble | FIG. 10e. |
| | wrap. | |

### Example 10

UV light-induced crosslinking was used to improve the mechanical properties and hydrophobicity of the bioplastic films. The wet bioplastic films of the disclosed subject matter (Formulation 1.2) were exposed to UVC (254 nm) and UVB (336 nm) light for different time intervals (0-120 minutes; see Table 9) and their water drop contact angle, a measure of the films' hydrophobicity, was measured using a goniometer (PG-X, PG1000). As demonstrated, an exposure time of approximately 15 minutes was found to be optimal for improving the hydrophobicity of the films. Contact angle measurements were repeated four times for each sample and an average value was taken.

TABLE 9
Shows the average contact angle measurements for UVC-
and UVB-treated bioplastic films (Formulation 1.2)

| | Contact Angle/ | Contact Angle/ |
|---|---|---|
| Time | UVC-treated | UVB-treated |
| (minutes) | (degrees) | (degrees) |
| 0 | 84 | 84 |
| 15 | 120 | 109 |
| 30 | 112 | 93 |
| 60 | 85 | 81 |
| 120 | 63 | 53 |

1-25. (canceled)

26. A composite material comprising:
a bioplastic film, the bioplastic film including a first surface and a second surface, wherein the first surface denotes an inner facing surface and the second surface denotes an exterior facing surface,
wherein the bioplastic film is comprised of a polypeptide-based or polysaccharide-based biopolymer, or a mixture of polypeptide-based and polysaccharide based biopolymer, and a bioplasticiser substance; and
wherein the inner product-facing surface of the bioplastic film comprises a coating that includes alpha-eleostearic acid as a major component
wherein the bioplasticiser is selected from the group consisting of: an alkyl citrate; an alkyl glycolate; an alkyl succinate; an alkyl glutarate; an alkyl stearate; an alkyl oleate; any derivative thereof, including their free acid and alkali salt forms; an isosorbide; a cardanol; a polyhydric alcohol; any derivative thereof,
wherein the bioplasticiser is selected from the group consisting of: C1-C6 alkyl group;
or the bioplasticiser is a polycondensation product of a small molecule polycarboxylic acid selected from the group consisting of: a citrate; a succinate; a glutarate; and a polyol selected from the group consisting of: glycerol; ethylene glycol; and propylene glycol.

27. The composite material of claim 26, wherein the polypeptide biopolymer is a synthetic or natural protein-derived biopolymer.

28. The composite material of claim 26, wherein the bioplasticiser is a polysaccharide-based biopolymer selected from the group consisting of: starch, cellulose, glycogen, chitosan, and combinations or derivatives thereof.

29. The composite material of claim 26, wherein the bioplasticiser is triethylcitrate (TEC).

30. The composite material of claim 26, wherein the bioplasticiser is a poly(glycerol-citrate) (PGC).

31. The composite material of claim 26, wherein the coating comprises alpha-eleostearic acid in an amount of greater than 55 wt %.

32. The composite material of claim 26, wherein the coating comprises tung oil or bitter melon seed oil or a derivative thereof.

33. The composite material of claim 26, further comprising:
a sensor substance;
wherein the sensor substance is selected from the group consisting of: a pH sensor substance, and a microbial sensor substance.

34. The composite material of claim 33, wherein the pH sensor substance is at least one pH indicator molecule.

35. The composite material of claim 26, further comprising:
an antimicrobial material or composition.

36. The composite material of claim 35, wherein the antimicrobial material or composition comprises diatomaceous earth.

37. The composite material of claim 26, wherein the composite material is flexible and transparent.

38. The composite material of claim 26, wherein at least one of the first surface and second surface of the bioplastic film includes an ink-printable substrate.

39. The composite material of claim 38, wherein the ink-printable substrate is configured for use with an ink selected from the group consisting of a biodegradable ink, a compostable ink, and a conductive ink.

40. The composite material of claim 26, wherein the composite material is configured for use in: packaging, including smart packaging, bioplastic bags and wrapping, including wrapping for domestic and agricultural articles; coatings, including smart coatings and spray coatings; bubble wrap; or single-use electronic devices, including single-use sensors.

41. The composite material of claim 26, wherein the alkyl group is at least one C2-C4 alkyl group.

42. The composite material of claim 26, wherein the biopolymer is a protein-derived biopolymer comprising a hydrolysed protein, including a gelatine.

43. A method for the production of a composite material, the method comprising:
providing a polypeptide-based biopolymer, wherein the polypeptide-based biopolymer is dissolved in water in a ratio by weight of: at most 1:10;
combining the dissolved polypeptide-based biopolymer with a small molecule hydrophilic bioplasticiser to form a polypeptide-based biopolymer/bioplasticiser solution;
adding the small molecule hydrophilic bioplasticiser to the polypeptide-based biopolymer/bioplasticiser solution in a mixing ratio by weight with respect to itself and the polypeptide-based biopolymer of: at most 50 w/w % and at least 0.01 w/w %;
using the polypeptide-based biopolymer/bioplasticiser solution to generate a bioplastic film; and
applying a coating comprising alpha-eleostearic acid as a major component to at least one surface of the bioplastic film,
wherein the polypeptide-based biopolymer comprises gelatine and the hydrophilic bioplasticiser comprises poly(glycerol-citrate) (PGC).

44. The method of claim 43, wherein the polypeptide-based biopolymer comprises gelatine and the hydrophilic bioplasticiser comprises triethylcitrate (TEC).

45. The method of claim 43, further comprising:
blending a pH sensor substance with the biopolymer/bioplasticiser solution.

46. The method of claim 43, wherein the polypeptide-based biopolymer comprises gelatine and the hydrophilic bioplasticiser comprises triethylcitrate (TEC).

47. The method of claim 43, further comprising:
blending an antimicrobial material or composition with the biopolymer/bioplasticiser solution, wherein the antimicrobial material or composition is diatomaceous earth blended in a mixing ratio of: at most 2 w/w % and at least 0.01 w/w %.

48. The method of claim 43, wherein the applying a coating comprising alpha-eleostearic acid as a major component includes at least one of dip coating and spray coating.

49. The method of claim 43, further comprising at least one of:
using a three-dimensional mould to generate the composite material;
configuring the composite material as a protective packaging product; and
configuring the composite material to be sealed together to produce a bubble wrap product.
